(19) United States
(12) Patent Application Publication
(10) Pub. No.: US 2008/0263299 A1
(43) Pub. Date: Oct. 23, 2008

(54) Storage System and Control Method Thereof

(76) Inventor: Susumu Suzuki, Oiso (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/017,441

(22) Filed: Jan. 22, 2008

(30) Foreign Application Priority Data
Apr. 23, 2007 (JP) 2007-112530

(51) Int. Cl. G06F 12/00

(52) U.S. Cl. 711/162; 711/E12.001

(57) ABSTRACT

A storage system and a control method thereof that can avoid performance degradation of a write command from a host are provided. In the storage system, when a request for conversion from snapshot to actual data copy is received, first, a copy difference table is scanned from its leading bit without deleting a pair of original volume and snapshot in a pair table, non-copy data is copied from the original volume to a pool volume, a corresponding bit in the copy difference table is changed to a copied one after the copying is completed, and a corresponding bit in the data match difference table is changed to match. Regarding all bits in the copy difference table, the above-mentioned processed is completed, and thereafter backup type of the pair table is changed to actual data copy.

### CROSS-REFERENCE TO RELATED APPLICATION

The present application claims priority from Japanese Patent Application No. JP 2007-112530 filed on Apr. 23, 2007, the content of which is hereby incorporated by reference into this application.

### TECHNICAL FIELD OF THE INVENTION

The present invention relates to a storage system and a control method thereof, and in particular to an effective technique suitable for application to conversion between snapshot and actual data copy.

### BACKGROUND OF THE INVENTION

According to examination conducted by the inventor of the present invention, there are snapshot and actual data copy for data backup in a storage system. The snapshot is for reducing volume capacity to be used by copying data before writing in a saving area at a write time from a host to original volume (copy-on-write operation). On the other hand, since all data in the original volume is copied to real volume in the actual data copy, volume capacity to be used becomes equal to the original volume. Copying all data largely influences performance of the whole system. (Refer to Japanese Patent Application Laid-open Publication No. 2006-31579.)

In the storage system, as described above, the snapshot is effective for the capacity reduction and performance to the whole system, but the copy-on-write operation increases overhead of a write command. Since all data is copied independently of a write command in the actual data copy, overhead of the write command is not influenced.

In general, a user selectively uses either of the snapshot and the actual data copy according to a backup purpose such that he/she utilizes the snapshot for fine setting of backup points like data ware house and utilizes the actual data copy for periodical backup.

However, it is impossible to convert data created by the snapshot to the actual data copy. Therefore, after backup points is set on trial by the snapshot, backing up all data at selected backup points results in degradation in performance of a write command. Thus, in the conventional method, after the snapshot has been performed, performance degradation of a write command from a host is unavoidable.

In view of these circumstances, an object of the present invention is to solve the problem and provide a storage system and a control method thereof that can avoid performance degradation of a write command from a host.

The typical ones of the inventions disclosed in this application will be briefly described as follows.

### SUMMARY OF THE INVENTION

In a storage system and a control method thereof according to the present invention, when a request for conversion from snapshot to actual data copy is received, conversion from the snapshot to the actual data copy is made possible by copying data on original volume to an area different from the original volume. Thereby, backup aspects are selectively used arbitrarily according to priority of volume capacity, write command overhead, and system performance.

That is, in the present invention, when a request for conversion from snapshot to actual data copy is received, a copy difference table is scanned from a leading bit thereof without deleting a pair of original volume and snapshot volume in a pair table, non-copied data is copied from the original volume to a pool volume. After the copying has been completed, a corresponding bit in the copy difference table is changed to a copied bit, and a corresponding bit in a data match difference table is changed to match. When processings to all bits in the copy difference table have been completed, the backup type of the pair table is changed to the actual data copy.

The effects obtained by typical aspects of the present invention will be briefly described below.

According to the present invention, since a copy-on-write operation to an original volume does not occur, performance degradation of a write command from a host can be avoided.

### BRIEF DESCRIPTIONS OF THE DRAWINGS

FIG. 1 is a diagram showing a whole configuration of a storage system according to an embodiment of the present invention;

FIG. 2 is a diagram showing a main section configuration of the storage system according to the embodiment of the present invention;

FIG. 3 is a diagram showing a configuration of a pair table in the storage system according to the embodiment of the present invention;

FIG. 4A is a diagram showing configurations of snapshot volume tables in the storage system according to the embodiment of the present invention;

FIG. 4B is a diagram showing configurations of snapshot volume tables in the storage system according to the embodiment of the present invention;

FIG. 5 is a diagram showing a configuration of a pool volume table in the storage system according to the embodiment of the present invention;

FIG. 6A is a diagram showing concepts of a read operation from a host to Original Volume in the storage system according to the embodiment of the present invention;

FIG. 6B is a diagram showing concepts of a read operation from a host to Original Volume in the storage system according to the embodiment of the present invention;

FIG. 7A is a diagram showing a concept of a read operation from a host to Original Volume in the storage system according to the embodiment of the present invention;

FIG. 7B is a diagram showing a concept of the read operation from the host to Original Volume in the storage system according to the embodiment of the present invention;

FIG. 8 is a diagram showing an operation flow in FIG. 7 in the storage system according to the embodiment of the present invention;

FIG. 9 is a diagram showing concepts of a read operation from a host to Snapshot Volume in the storage system according to the embodiment of the present invention;

FIG. 10 is a diagram showing an operation flow in FIG. 9 in the storage system according to the embodiment of the present invention;

FIG. 11 is a diagram showing concepts of a read operation from a host to Snapshot Volume in the storage system according to the embodiment of the present invention;

FIG. 12 is a diagram showing an operation flow in FIG. 11 in the storage system according to the embodiment of the present invention;

FIG. 13 is a diagram showing an operation flow of conversion from snapshot to actual data copy in the storage system according to the embodiment of the present invention;

FIG. 14 is a diagram showing a state transition in the storage system according to the embodiment of the present invention;

FIG. 15 is a diagram for explaining a consistency group in the storage system according to the embodiment of the present invention;

FIG. 16 is a diagram for explaining a midrange system configuration in the storage system according to the embodiment of the present invention;

FIG. 17 is a diagram for explaining a pattern 1 of a control method of the midrange system configuration in the storage system according to the embodiment of the present invention;

FIG. 18 is a diagram for explaining a pattern 2 of a control method of the midrange system configuration in the storage system according to the embodiment of the present invention;

FIG. 19 is a diagram for explaining a pattern 3 of a control method of the midrange system configuration in the storage system according to the embodiment of the present invention;

FIG. 20 is a diagram for explaining an external connection in the storage system according to the embodiment of the present invention; and

FIG. 21 is a diagram showing a configuration of an external connection mapping table in the storage system according to the embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### Concept of Embodiment of the Present Invention

The present invention is applied to a storage system and control method thereof comprising a channel control unit (channel adaptor) that receives a request for a read operation or a write operation from a host to control the read operation or the write operation, a storage device (storage unit) that stores data obtained according to the read operation or the write operation, a storage device control unit (disk adaptor) that controls a read operation or a write operation of data to the storage device, a shared memory in which control information fed by the channel control unit and the storage device control unit is stored, and a cache memory in which data fed between the channel control unit and the storage device control unit is temporality stored.

In a configuration of such a storage system, Original Volume, Snapshot Volume, and POOL Volume are set in a storage apparatus. A shared memory has a pair table, a Snapshot Volume table, a POOL Volume table, a copy difference table, and a data match difference table.

Here, respective terms used for explanation of the present invention will be defined.

The term “Original Volume” is a logical volume in which original data has been stored when Snapshot is created.

The term “Snapshot Volume” is a virtual logical volume constituting Snapshot when Snapshot is created.

The term “POOL Volume” is a logical volume for storing actual data of Snapshot Volume therein after Snapshot has been created.

The term “pair table” is a table for managing pair correspondence between Original Volume and Snapshot Volume.

The term “Snapshot Volume table” is a table for managing actual data positions in Snapshot Volume for each location. The Snapshot Volume table comprises a header section and a data section. The header section is for managing use/non-use of the data section in a bitmap manner. The data section is stored with an entry number in Pool when actual data of each Snapshot Volume is present in POOL Volume. When actual data is not present in POOL Volume, an invalid value is stored in the data section.

The term “POOL Volume table” is stored with an entry number in POOL and an address of actual data corresponding to entry thereof. The POOL Volume table is shared by a plurality of pairs.

The term “copy difference table” is a difference table showing whether data has been copied from Original Volume to POOL Volume. Allocation of one bit/data is performed in the copy difference table.

The term “data match difference table” is a difference table showing whether data in Original Volume and data in POOL Volume match with each other. Allocation of one bit/data is performed in the data match difference table. The data match difference table is valid only when the copy difference table is in OFF.

A term “background copy” is data copy from Original Volume to POOL Volume performed independently of a read processing and a write processing from a host.

The term “snapshot” is a processing for copying data before written to POOL Volume present in a saving area, at a write time from a host to Original Volume (copy-on-write).

The term “actual data copy” is a processing for copying all data in Original Volume to POOL Volume in actual volume.

<Whole Configuration of Storage System>

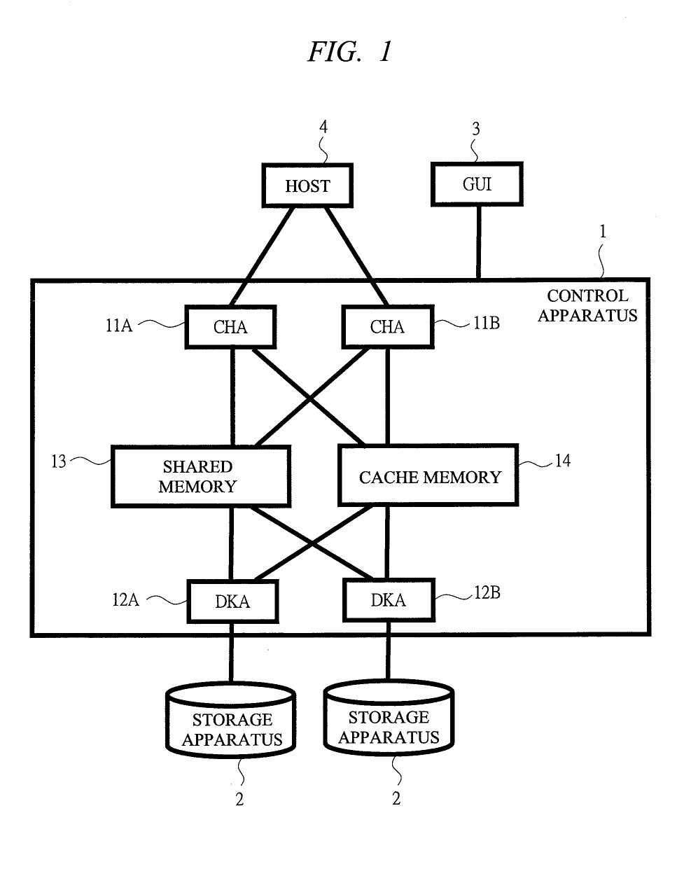

Referring to FIG. 1, one example of a whole configuration of a storage system according to an embodiment of the present invention will be explained. FIG. 1 is a diagram showing a whole configuration of a storage system according to the embodiment.

The storage system according to the embodiment is applied to a high-end system configuration (a midrange system configuration will be explained later), for example, and it includes a control apparatus 1 and a storage apparatus 2. The control apparatus 1 is connected with a GUI 3. This storage system is connected with a host 4 as an upper apparatus.

The control apparatus 1 includes a plurality of (two in FIG. 1) channel adapters (CHA) 11 (11A and 11B) receiving a request for a read operation or a write operation from the host 4 to control the read operation or the write operation, a plurality of (two in FIG. 1) disk adapters (DKA) 12 (12A and 12B) controlling the read operation or the write operation of data to the storage apparatus 2, a shared memory 13 in which control information fed between the CHA 11 and the DKA 12 is stored, and a cache memory 14 in which data fed between the CHA 11 and the DKA 12 is temporarily stored.

The CHA 11 is provided with a communication interface for performing communication with the host 4, and it has a function for performing transmission/reception of data input/output command or the like with the host 4. Especially, the CHA 11 also has a function for performing a snapshot creating processing, a read/write access operation from the host, a processing in a copying operation due to host access, conversion from snapshot to actual data copy, conversion from actual data copy to snapshot, a deleting processing of snapshot, and the like, as described later.

The shared memory 13 and the cache memory 14 are the storage memories shared by the CHA 11 and the DKA 12. The shared memory 13 is mainly utilized for storing control information or commands, while the cache memory 14 is mainly utilized for storing data. Especially, the shared memory 13 also stores tables such as a pair table, a pool volume table, a snapshot volume table, a copy difference table, and a data match difference table.

For example, when a data input/output request received from the host 4 by a certain CHA 11 is a write command, the CHA 11 writes the write command in the shared memory 13 and writes write data received from the host 4 into the cache memory 14. On the other hand, when the DKA 12 monitors the shared memory 13 and detects that a write command has been written in the shared memory 13, it reads the written data from the cache memory 14 according to the command to write the same in a disk drive in the storage apparatus 2.

When a data input/output request received from the host 4 by a certain CHA 11 is a read command, the CHA 11 examines whether data to be read is present in the cache memory 14. Here, when the data to be read is present in the cache memory 14, the CHA 11 transmits the data to the host 4. On the other hand, when the data is not present in the cache memory 14, the CHA 11 writes the read command in the shared memory 13 and monitors the shared memory 13. The DKA 12 that has detected that the read command has been written in the shared memory 13 reads data to be read from the disk drive in the storage apparatus 2 to write the same in the cache memory 14 and write such a fact in the shared memory 13. When the CHA 11 detects that the data to be read has been written in the cache memory 14, it transmits the data to the host 4.

Thus, transmission/reception of data is performed between the CHA 11 and the DKA 12 via the cache memory 14, and among date stored in the disk drive, data that is to be read or written by the CHA 11 or the DKA 12 is stored in the cache memory 14.

Incidentally, in addition to such a configuration that an instruction for data write or read from the CHA 11 to the DKA 12 is indirectly issued via the shared memory 13, for example, a configuration that an instruction for data write or data read from the CHA 11 to the DKA 12 is directly issued without interposition of the shared memory 13 can be adopted. The data input/output control unit may be configured by giving a function of the DKA 12 to the CHA 11.

The DKA 12 is connected to a plurality of disk drives storing data in the storage apparatus 2 to allow communication therewith, and it performs control on a write operation or a read operation of data to the disk drives. As described above, for example, the DKA 12 performs read/write of data to the disk drive according to a data input/output request received from the host 4 by the CHA 11.

Incidentally, in the embodiment, though the case that the shared memory 13 and the cache memory 14 are provided independently of the CHA 11 and the DKA 12 has been explained, the present invention is not limited to this case and a configuration that the shared memory 13 or the cache memory 14 is distributed in the CHA 11 and the DKA 12 can be adopted.

A configuration that at least two of the CHA 11, the DKA 12, the shared memory 13, and the cache memory 14 are united may be adopted.

The storage apparatus 2 includes many disk drives. Thereby, a large capacity of storage area can be provided to the host 4. The disk drive can comprise a data storage medium such as a hard disk drive or a plurality of hard disk drive constituting RAID (Redundant Arrays of Inexpensive Disks).

A logical volume that is a logical storage area can be set in a physical volume that is a physical storage area provided by the disk drive. Especially, the Original Volume, the Snapshot Volume, and the Pool Volume are set as the logical volumes, as described in detail later.

The storage apparatus 2 and the DKA 12 may be connected to each other directly, as shown in FIG. 1, or they may be connected via a network. In addition, the storage apparatus 2 may be integrated with the control apparatus 1.

The GUI 3 is a computer for performing maintenance and management of the control apparatus 1. For example, an operator can perform setting of a disk drive configuration in the storage apparatus 2, setting of a path that is a communication path between the host 4 and the CHA 11, setting of the logical volume, installation of a micro-program executed in the CHA 11 or the DKA 12, or the like by operating the GUI 3. Here, as the setting of the disk drive configuration in the storage apparatus 2, increase or decrease of the number of disk drives, change of a RAID configuration (change from RAID 1 to RAID 5, or the like), or the like can be performed.

In addition, works such as confirmation of an operating state of the control apparatus 1, identification of a failed section thereof, or installation of an operating system executed at the CHA 11 can be performed from the GUI 3. The setting or controlling may be performed by an operator or the like from a user interface included in the GUI 3 or a user interface of a management client displaying Web page provided by a Web server operating at the GUI 3. The operator or the like can perform setting of an object whose failure is to be monitored, content of the failure, setting of a notification destination of a failure, or the like by operating the GUI 3.

The GUI 3 can take not only an add-on aspect but also a built-in aspect in the control apparatus 1. In addition, the GUI 3 may be a dedicated computer for maintenance and management of the control apparatus 1 and the storage apparatus 2, or a general-purpose computer provided with maintenance and management functions may be used.

The host 4 is an information or data processing apparatus such as a computer with a CPU and a memory. Various programs are executed by the CPU provided in the host 4 so that various functions can be realized. The host 4 may be a personal computer or a workstation, for example, or it may be a mainframe computer. Especially, the host 4 can be utilized as a central computer in an automatic depositing and dispensing system of a bank, a seat reserving system of an aircraft, or the like.

In addition, the host 4 is connected to the control apparatus 1, for example, via SAN (Storage Area Network) to allow communication therewith. The SAN is a network for performing transmission/reception of data between the same and the host 4 utilizing a block that is a management unit of data in a storage resource provided by the storage apparatus 2 as a unit. Communication between the host 4 and the control apparatus 1 performed via the SAN is performed, for example, according to a fiber channel protocol. A data access request of block unit is transmitted from the host 4 to the control apparatus 1 according to the fiber channel protocol.

Furthermore, the host 4 may be directly connected to the control apparatus 1 without interposition of a network such as the SAN to allow communication therewith. Communication between the host 4 and the control apparatus 1 directly performed without interposition of a network is performed according to such a communication protocol as FICON (Fibre Connection) (registered trademark), ESCON (Enterprise System Connection) (registered trademark), ACONARC (Advanced Connection Architecture) (registered trademark), or FIBARC (Fibre Connection Architecture) (registered trademark). A data access request of block unit is transmitted from the host 4 to the control apparatus 1 according to the communication protocols.

Of course, in addition to the case that the host 4 and the control apparatus 1 are connected through the SAN or the case that they are directly connected without the SAN, they may be connected through LAN (Local Area Network). When the host 4 and the control apparatus 1 are connected through the LAN, communication can be performed according to, for example, TCP/IP (Transmission Control Protocol/Internet Protocol) protocol.

<Main Section Configuration of Storage System>

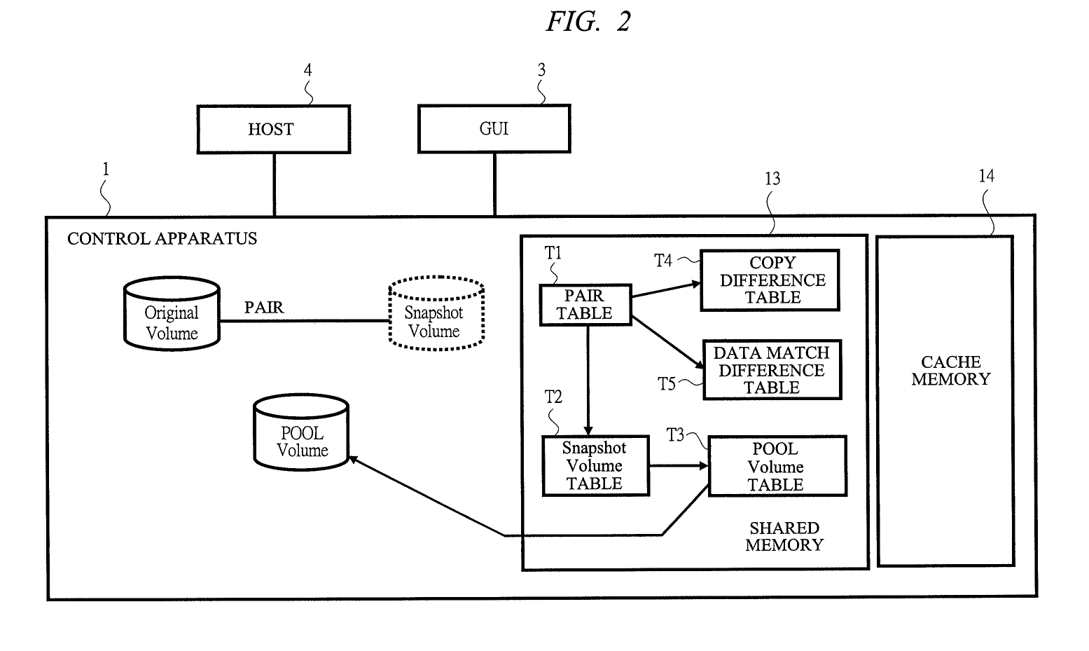

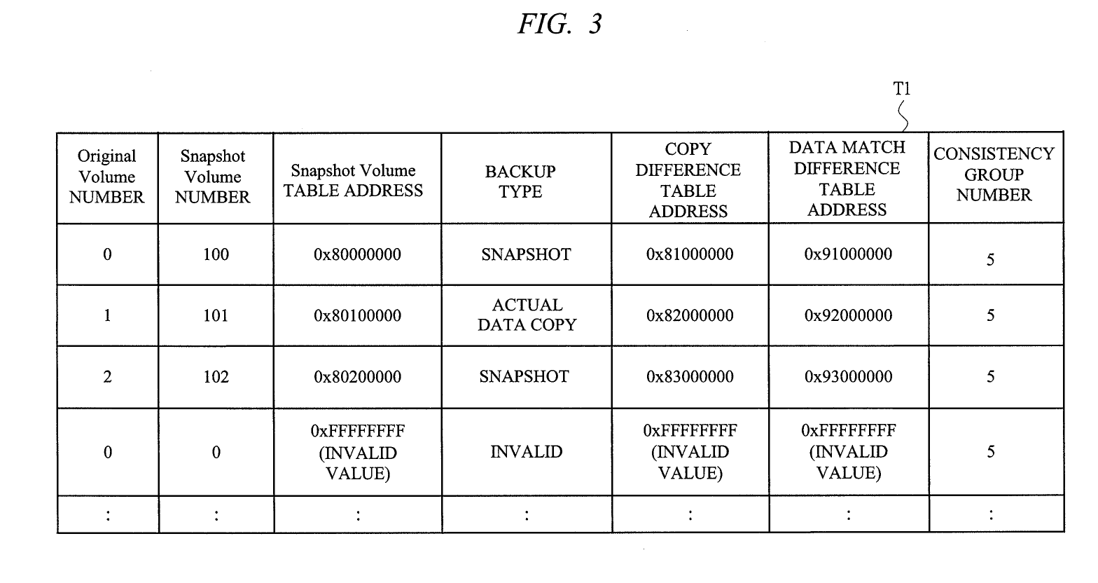

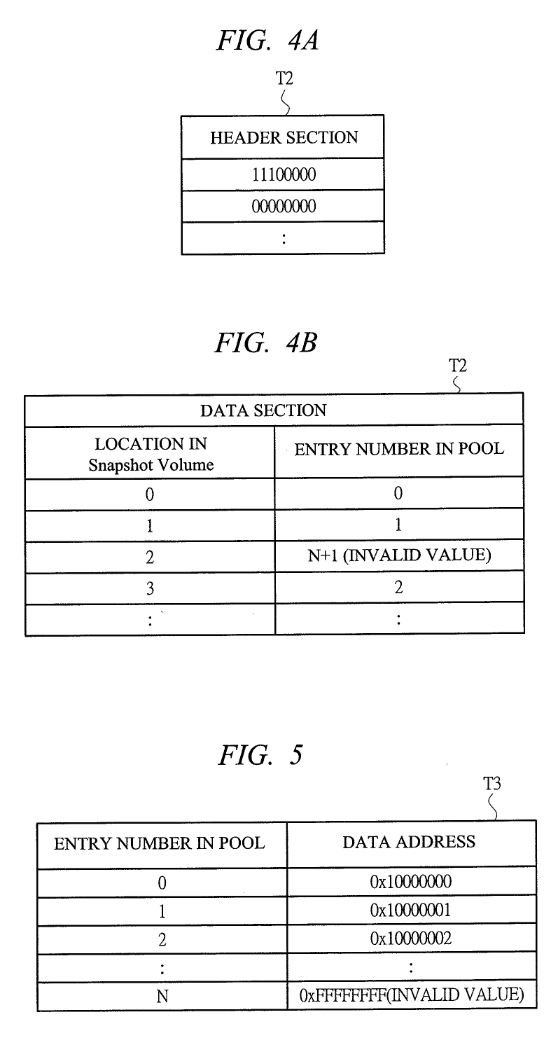

Referring to FIG. 2, one example of a main section configuration of the storage system according to an embodiment of the present invention will be explained. FIG. 2 is a diagram showing a main section configuration of the storage system according to the embodiment. Besides, a configuration of the pair table will explained referring to FIG. 3, a configuration of the snapshot volume table will be explained referring to FIG. 4, and a configuration of the pool volume table will be explained referring to FIG. 5.

In the configuration of the storage system described above, as shown in FIG. 2, Original Volume that is a logical volume in which original data has been stored at a creating time of Snapshot, Snapshot Volume that is a virtual logical volume serving as Snapshot at a creating time of Snapshot, and POOL Volume that is a logical volume for storing actual data of Snapshot Volume after Snapshot creation are set in the physical volume provided by the disk drive in the storage apparatus 2.

In addition, the shared memory 13 includes a pair table T1 managing pair correspondence between Original Volume and Snapshot Volume, a Snapshot Volume table T2 managing actual data positions in Snapshot Volume for each location, a POOL Volume table T3 where entry numbers in POOL and addresses of actual data corresponding to the entries are stored, a copy difference table T4 that indicates whether data has been copied from Original Volume to POOL Volume, and a data match different table T5 that indicates whether data in Original Volume and data in POOL Volume match with each other.

As shown in FIG. 3, the pair table T1 includes respective areas for storing Original Volume number, Snapshot Volume number, Snapshot Volume table address, backup type, copy difference table address, and data match difference table address, consistency group number. A pair correspondence between Original Volume and Snapshot Volume is managed according to this pair table T1.

As shown in FIGS. 4A and 4B, the Snapshot Volume table T2 comprises a header section and a data section. As shown in FIG. 4A, the header section is for bitmap management of use/non-use of the data section (“1” corresponds to use while “0” corresponds to non-use). As shown in FIG. 4B, the data section includes respective areas for storing locations in Snapshot Volume and for storing entry numbers in POOL. This data section is stored with an entry number in POOL when actual data in each Snapshot Volume is in POOL volume. When actual data is not present in POOL Volume, an invalid value is stored in the data section. Actual data positions in Snapshot Volume are managed for each location by this Snapshot Volume table T2.

As shown in FIG. 5, the POOL Volume table T3 includes respective areas for storing an entry number in POOL and for storing data address. The entry number in POOL and an address of actual data corresponding to the entry are stored in the respective storing areas. This POOL Volume table T3 is shared by a plurality of pairs.

The copy difference Table T4 (not shown) is allocated with one bit/data and indicates whether data has been copied from Original Volume to POOL volume. In each one bit, “1” (ON) indicates non-copied (an initial value), while “0” (OFF) indicates copied.

The data match difference table T5 is made valid only when the copy difference table T4 is in OFF, it is allocated with one bit/data (not shown), and it indicates whether data in Original Volume and data in POOL data match with each other. In each one bit, “1” (ON) indicates mismatch (an initial value), while “0” (OFF) indicates match.

<Snapshot Creating Processing>

In a creating processing of the snapshot, the following (1) to (4) are performed in the CHA 11. A snapshot creation request can be issued from the host 4 or the GUI 3.

(1) An entry where the backup type in the pair table T1 is invalid is retrieved, and an Original Volume number and a Snapshot Volume number are registered. The header section in the Snapshot Volume table T2 is retrieved and an address of an unused data section is set in a Snapshot Volume table address. In addition, the backup type is changed to the snapshot.

(2) An entry number in POOL in the Snapshot Volume table T2 is changed to an invalid value.

(3) All bits in the copy difference table T4 are turned ON (initialization).

(4) All bits in the data match difference table T5 are turned ON (initialization).

Thus, the creating processing of snapshot can be performed.

<Read/Write Access Operation from Host>

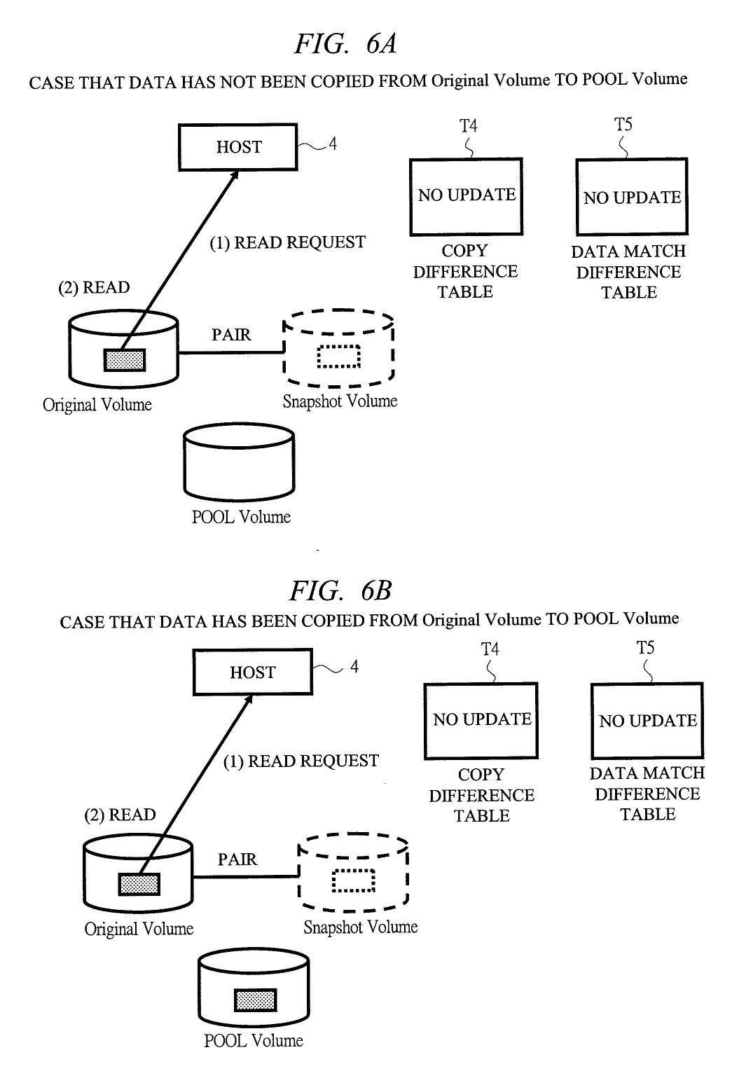

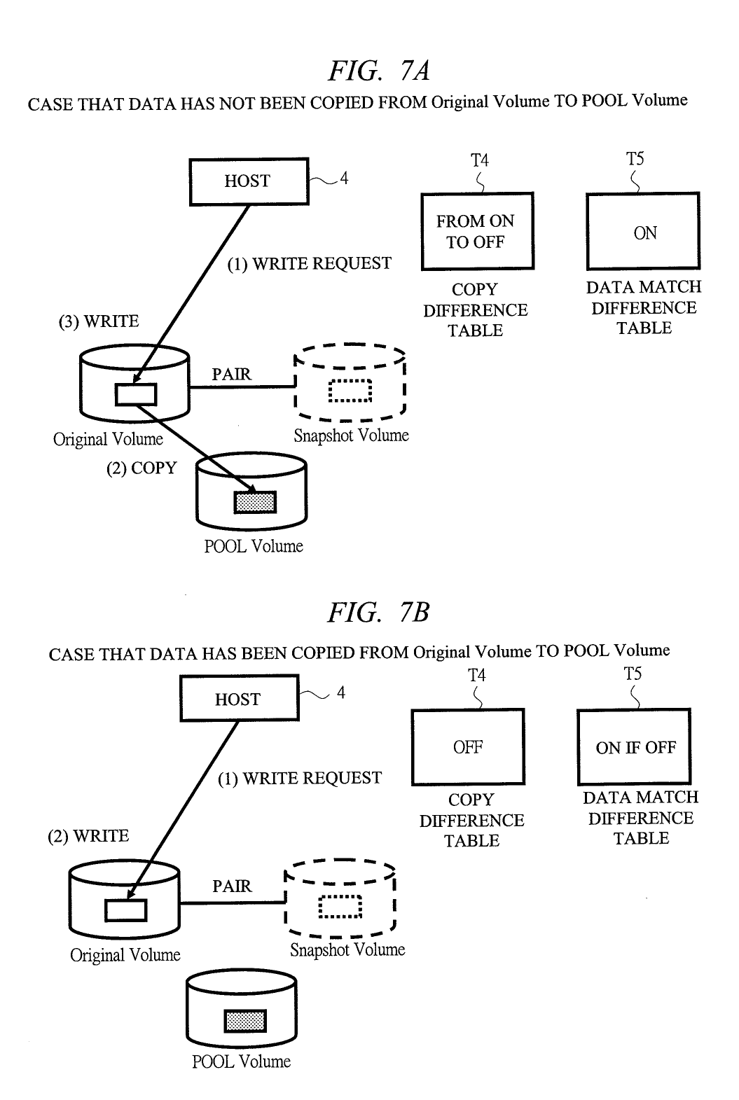

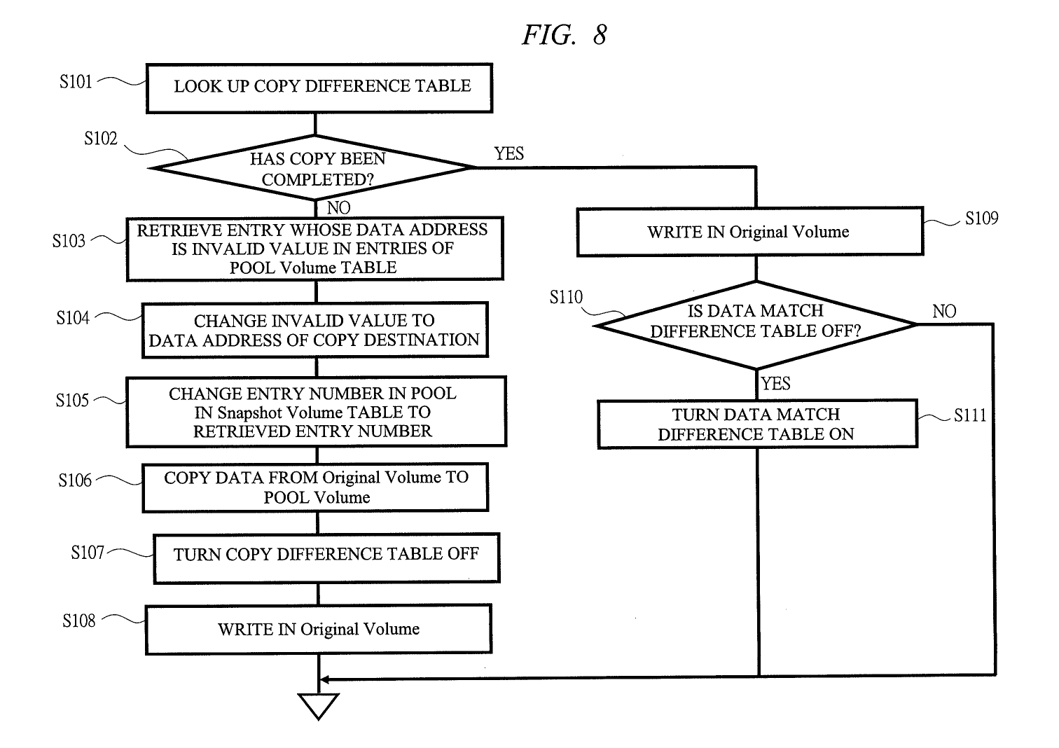

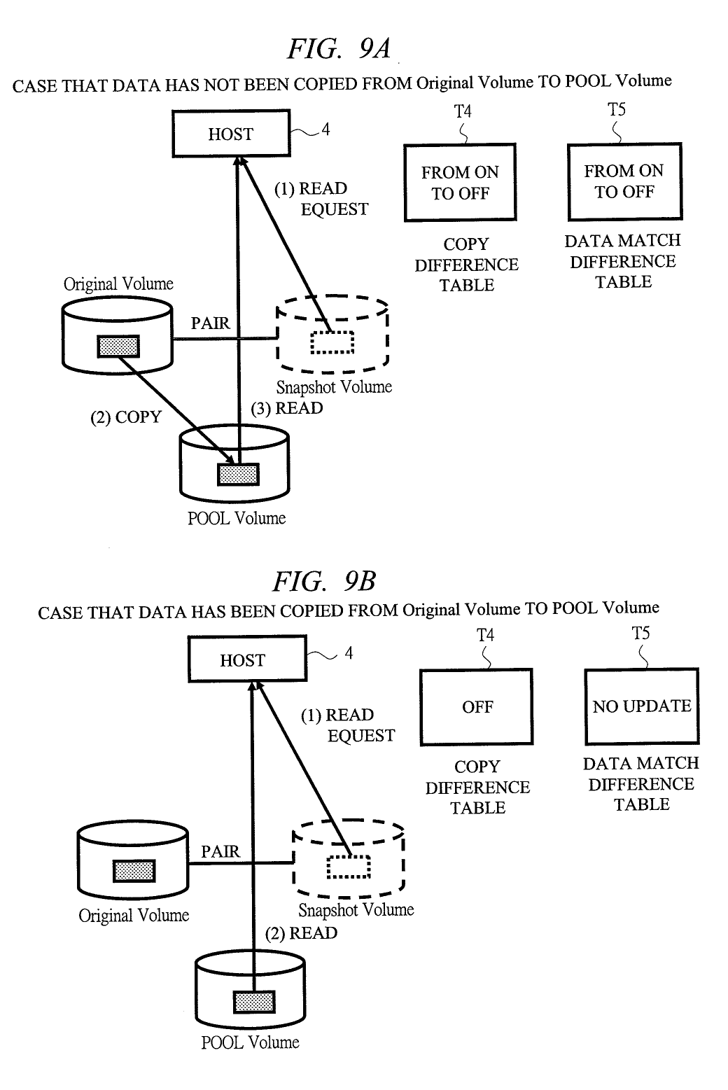

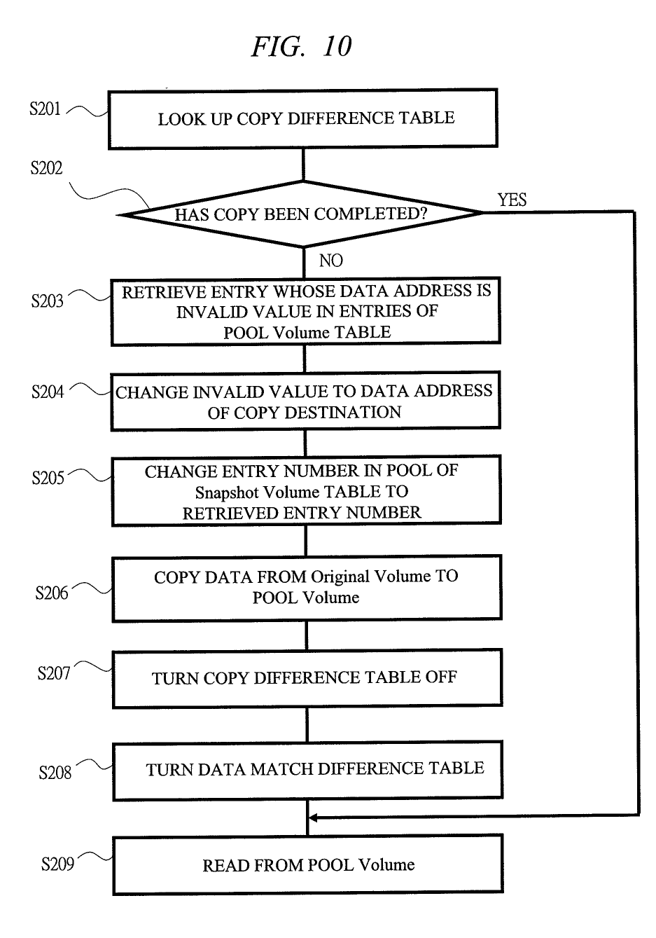

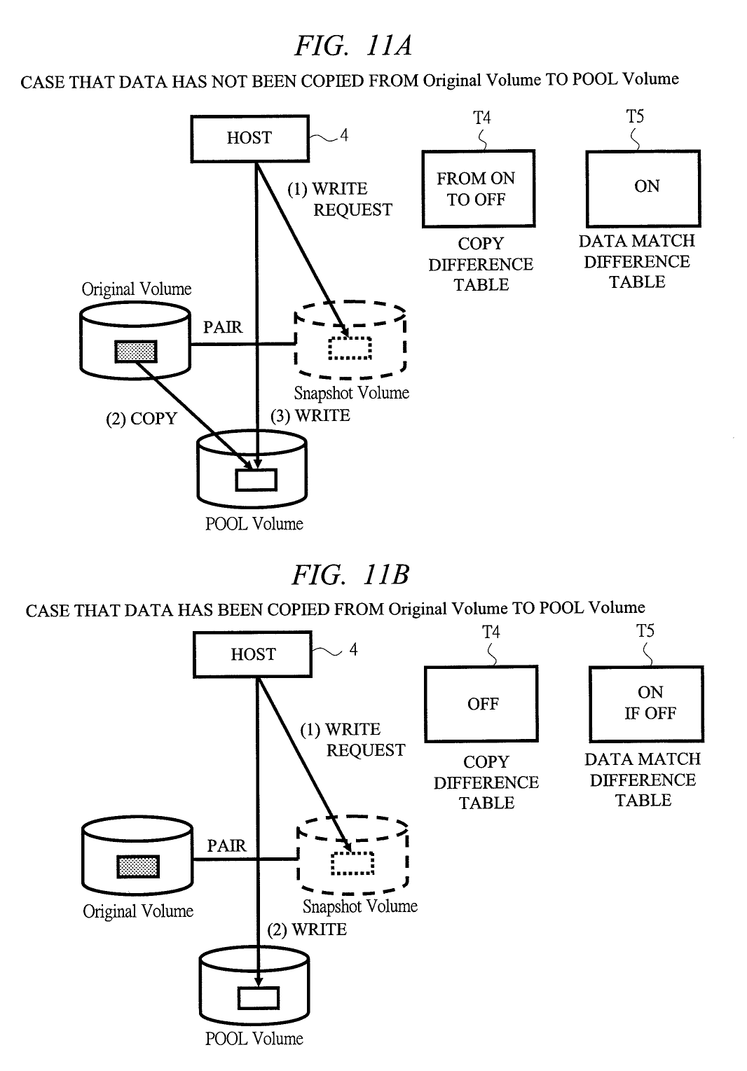

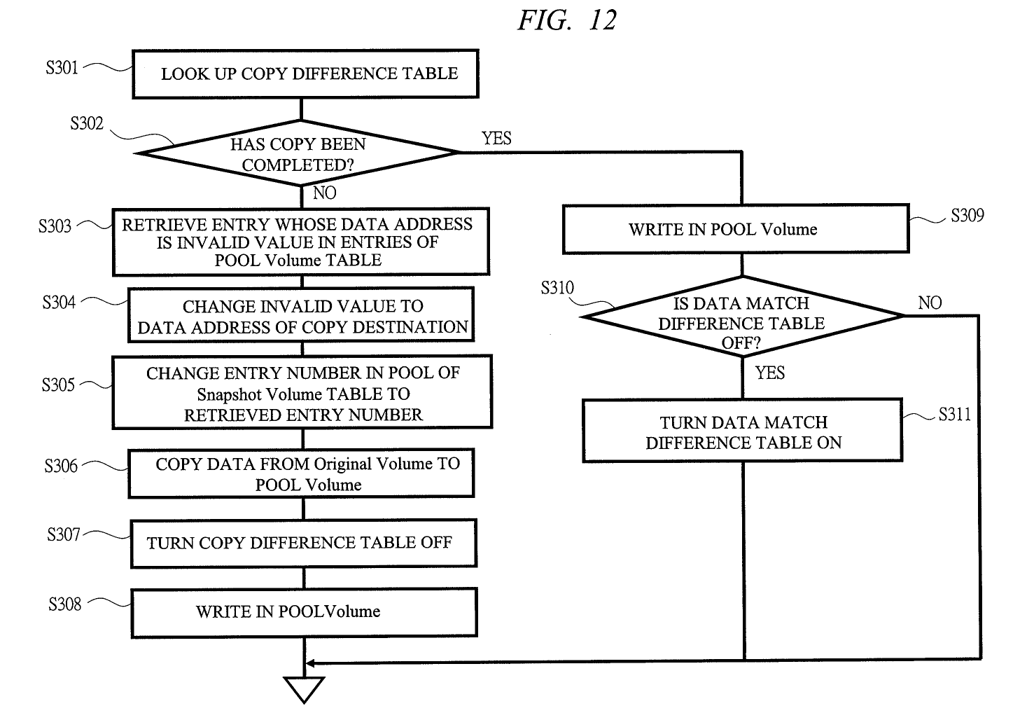

After the snapshot creation, read/write operations from the host to Original Volume and Snapshot Volume are performed in the CHA 11 in the following manner. Referring to FIG. 6 to FIG. 12, one example of these operations will be explained. FIG. 6 is a diagram showing a concept of a read operation from the host to Original Volume, FIG. 7 is a diagram showing a concept of a write operation from the host to Original Volume, FIG. 8 is a diagram showing an operation flow shown in FIG. 7, FIG. 9 is a diagram showing a concept of a read operation from the host to Snapshot Volume, FIG. 10 is a diagram showing an operation flow shown in FIG. 9, FIG. 11 is a diagram showing a concept of a write operation from the host to Snapshot Volume, and FIG. 12 is a diagram showing an operation flow shown in FIG. 11.

(1) In a read operation from the host 4 to Original Volume, when data has not been copied from Original Volume to POOL volume, as shown in FIG. 6A, or when data has been copied from the former to the latter, as shown in FIG. 6B, data in Original Volume is read. In this case, the copy difference table T4 and the data match difference table T5 are not updated.

(2) In a write operation from the host 5 to Original Volume, the copy difference table T4 is looked up, and when data has not been copied from Original Volume to POOL volume, as shown in FIG. 7A, write data is written in Original Volume after copied. In this case, the copy difference table T4 is updated from ON to OFF, and the data match difference table T5 is kept in ON. As shown in FIG. 7B, when the copying has been completed, write data is written in Original Volume. In this case, the copy difference table T4 is kept in OFF, while the data match difference table T5 is updated from OFF to ON.

As shown in FIG. 8, in a specific processing procedure, first, by looking up the copy difference table T4 (S101), determination is made about whether data should be copied from Original Volume to POOL Volume (S102).

As the determination result at Step S102, when data has not been copied from Original Volume to POOL volume (NO), an entry of entries in the POOL volume table T3 whose data address is an invalid value is retrieved (S103). The invalid value of the retrieved entry is changed to a data address of a copy destination (S104), and an entry number in POOL in the Snapshot Volume table T2 is changed to a retrieved entry number (S105).

The data is copied from Original Volume to POOL Volume (S106). After copying, the copy difference table T4 is turned OFF (S107), write data is written in Original Volume (S108), and the processing is terminated.

On the other hand, as the determination result at step S102, when data has already been copied from Original Volume to POOL Volume (YES), write data is written in Original Volume (S109). Further, determination is made about whether the data match difference table T5 is in OFF (S110).

As the determination result at step S110, when the data match difference table T5 is in OFF (YES), the data match difference table T5 is turned ON (S111). On the other hand, when the data match difference table T5 is not in OFF (NO), it is in ON so that the processing is terminated as it is.

(3) In a read operation from the host to Snapshot Volume, as shown in FIG. 9A, the copy difference table T4 is looked up, and when data has not been copied from Original Volume to POOL volume, data in POOL Volume is read after copying. In this case, the copy difference table T4 is updated from ON to OFF, and the data match difference table T5 is updated from ON to OFF. As shown in FIG. 9B, when the copying has been completed, data in POOL Volume is read. In this case, the copy difference table T4 is kept in OFF, and the data match difference table T5 is not updated.

As shown in FIG. 10, in a specific processing procedure, first, by looking up the copy difference table T4 (S201), determination is made about whether data has been copied from Original Volume to POOL Volume (S202).

As the determination result at step S202, when data has not been copied from Original Volume to POOL Volume (NO), an entry of entries in POOL Volume table T3 whose data address is an invalid value is retrieved (S203). The invalid value of the retrieved entry is changed to a data address of a copy destination (S204), and an entry number in POOL in the Snapshot Volume table T2 is changed to a retrieved entry number (S205).

The data is copied from Original Volume to POOL volume (S206). After copying, the copy difference table T4 is turned OFF (S207), the data match difference table T5 is turned OFF (S208), data is read from POOL Volume (S209), and the processing is terminated.

On the other hand, as the determination result at step S202, when the data has already been copied from Original Volume to POOL Volume (YES), the data is read from POOL Volume (S209), and the processing is terminated.

(4) In a write operation from the host 4 to Snapshot Volume, the copy difference table T4 is looked up, and when data has not been copied from Original Volume to POOL volume, as shown in FIG. 11A, write data is written in POOL Volume after copying. In this case, the copy difference table T4 is updated from ON to OFF, and the data match difference table T5 is kept in ON. As shown in FIG. 11B, when the copying has been completed, the write data is written in POOL Volume. In this case, the copy difference table T4 is kept in OFF, the data match difference table T5 is updated to ON, if it is in OFF.

In a specific processing procedure, as shown in FIG. 12, by first looking up the copy difference table T4 (S301), determination is made about whether data has been copied from Original Volume to POOL Volume (S302).

As the determination result at step S302, when data has not been copied from Original Volume to POOL Volume (NO), an entry of entries in POOL Volume table T3 whose data address is an invalid value is retrieved (S303). The invalid value of the retrieved entry is changed to a data address of a copy destination (S304), and an entry number in POOL in the Snapshot Volume table T2 is changed to a retrieved entry number (S305).

The data is copied from Original Volume to POOL volume (S306). After copying, the copy difference table T4 is turned OFF (S307), write data is written in POOL Volume (S308), and the processing is terminated.

On the other hand, as the determination result at step S302, when the data has already been copied from Original Volume to POOL Volume (YES), write data is written in POOL Volume (S309). In addition, determination is made about whether the data match difference table T5 is OFF (S310).

As the determination result at step S310, when the data match difference table T5 is OFF (YES), it is turned ON (S311). On the other hand, if the data match difference table T5 is no OFF (ON), it is in ON, so that the processing is terminated as it is.

Thus, after the snapshot creation, read/write operations from the host 4 to Original Volume and Snapshot Volume can be performed.

<Processing in Copying Operation Based Upon Host Access>

In a data copying processing from Original Volume to POOL Volume generated by read/write access from the host 4, the following (1) to (4) are performed in the CHA 11.

(1) An entry number in POOL of an entry of entries in POOL Volume table T3 whose data address is an invalid value is retrieved.

(2) A data address corresponding to the entry number in POOL in the above (1) is updated to a data address copying data actually.

(3) An entry number in POOL in the Snapshot Volume table T2 is updated to the entry number in POOL described in the above (1).

(4) Data is copied from Original Volume to POOL Volume.

Thus, the data copying processing from Original Volume to POOL Volume generated due to read/write access from the host 4 can be performed.

<Conversion from Snapshot to Actual Data Copy>

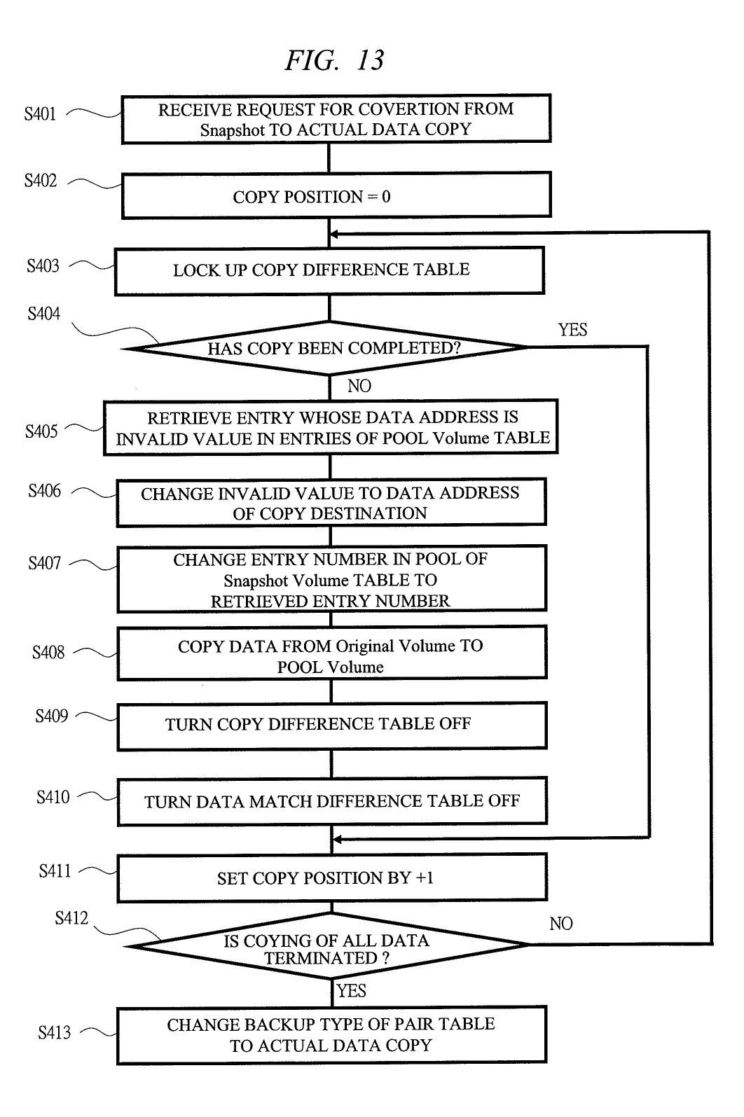

When a request for conversion from snapshot to actual data copy is received, the following (1) to (2) are performed in the CHA 11 without deleting pair. The conversion request can be issued from the host 4 and the CUI 3. Referring to FIG. 13, the one example of this operation will be explained. FIG. 13 is a diagram showing an operation flow of conversion from snapshot to actual data copy.

(1) The copy difference table T4S is scanned from a leading bit thereof and non-copied data is copied from Original Volume to POOL Volume (background copy). After copying is completed, corresponding bits in the copy difference table T4 and the data match difference table T5 are turned OFF.

(2) After the above processing (1) to all bits in the copy difference table T4 is completed, the backup type of the pair table T1 is changed to actual data copy.

As shown in FIG. 13, in a specific processing procedure, when a request for conversion from snapshot to actual data copy is received from the host 4 or the GUI 3 (S401), first, after copy position=0 is set (S402), the copy difference table T4 is looked up (S403), and determination is made about whether data has been copied from Original Volume to POOL Volume (S404).

As the determination result at step S404, when the data has not been copied from Original Volume to POOL Volume (NO), an entry of entries in POOL Volume table T3 whose data address is an invalid value is retrieved (S405). The invalid value of the retrieved entry is changed to a data address of a copy destination (S406), and an entry number in POOL in the Snapshot Volume table T2 is changed to a retrieved entry number (S407).

The data is copied from Original Volume to POOL Volume (408). After copied, the copy difference table T4 is turned OFF (S409) and the data match difference table T5 is turned OFF (S410).

Next, after the copy position is changed by +1 (S411), determination is made about whether copy of all data has been completed (S412). As the determination result at step S412, when copy of all data has been completed (YES), the backup type of the pair table T1 is changed to actual data copy (S414), and the processing is terminated. On the other hand, when the copy of all data has not been completed (NO), the processing from step S403 is repeated.

As the determination result at step S404, when the data has already been copied from Original Volume to POOL Volume (YES), the control proceeds to step S411 where the processing continues.

Thus, the processing for conversion from snapshot to actual data copy can be performed.

<Conversion from Actual Data Copy to Snapshot>

When a request for conversion from actual data copy to snapshot is received, the following (1) to (4) are performed at the CHA 11 without performing pair deletion. The conversion request can be issued from the host 4 or the GUI 3.

(1) The backup type of the pair table T1 is changed to snapshot.

(2) The data match difference table T5S is scanned from a leading bit thereof, and an entry number in POOL at location having data match is changed to an invalid value.

(3) A data address of the entry number in POOL corresponding to the above (2) in the POOL Volume table T3 is changed to an invalid value.

(4) A bit corresponding to the above (2) in the copy difference table T4 is turned ON.

Thus, the processing for conversion from actual data copy to snapshot can be performed.

<Snapshot Deleting Processing>

In a snapshot deleting processing, the following (1) to (3) are performed at the CHA 11.

(1) A data address on the POOL Volume table T3 corresponding to an entry number in POOL that is not an invalid value in the Snapshot Volume table T2 is changed to an invalid value.

(2) A corresponding use bit corresponding in the header section on the Snapshot Volume table T2 of the above (1) is changed to 0 and all the entry numbers in POOL are changed to invalid values.

(3) The Original Volume number and the Snapshot Volume number on the pair table T1 are cleared to 0, and the Snapshot Volume table address and the backup type are changed to an invalid value.

Thus the snapshot deleting processing can be performed.

<State Transition>

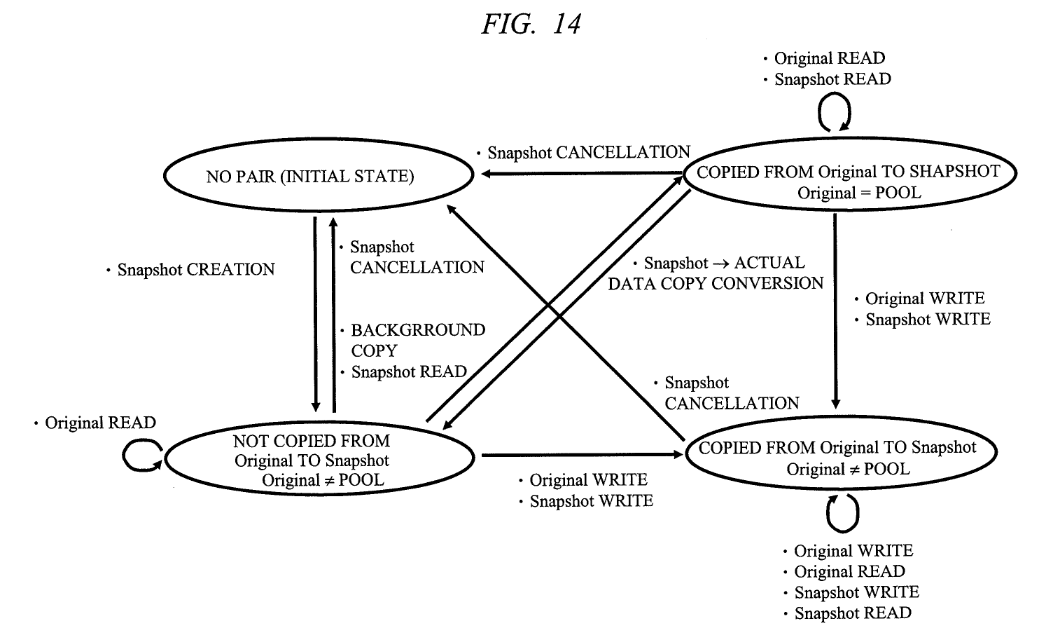

By arbitrarily combining the snapshot creating processing, the read/write access operation from the host, the processing in the copying operation based upon the host access, the conversion from the snapshot to the actual data copy, the conversion from the actual data copy to the snapshot, and the snapshot deleting processing explained above to perform the combined processings, a state transition as shown in FIG. 14 can be realized. Referring to FIG. 14, one example of the state transition will be explained. FIG. 14 is a diagram showing a state transition.

As the states, there are four states of a first state having no pair (an initial state), a second state where copying has not been performed from Original Volume to Snapshot Volume (Original Volume≠POOL Volume), a third state where copying has been performed from Original Volume to Snapshot Volume (Original Volume≠POOL Volume), and a fourth state where copying has been performed from Original Volume to Snapshot Volume (Original Volume=POOL Volume).

Transition from the first state to the second state can occur according to Snapshot creation. Reverse transition thereto can occur according to Snapshot deletion. Transition from the second state to the third state can occur according to Original Volume write or Snapshot Volume write. Transition from the second state to the fourth state can occur according to background copy or Snapshot Volume read. Reverse transition thereto can occur according to conversion from Snapshot to actual data copy. Transition from the third state to the first state can occur according to Snapshot deletion. Transition from the fourth state to the first state can occur according to Snapshot deletion. Transition from the fourth state to the third state can occur according to Original Volume write or Snapshot Volume write.

In the second state, Original Volume read is performed. In the third state, Original Volume write, Original Volume read, Snapshot Volume write, and Snapshot Volume read are performed. In the fourth state, Original Volume read and Snapshot Volume read are performed.

Thus, transition among the first state, the second state, the third state, and the fourth state can be conducted arbitrarily.

<Consistency Group>

In the present invention, the respective processings of the snapshot creating processing, the read/write access operation from the host, the processing in the copying operation based upon the host access, the conversion from the snapshot to the actual data copy, the conversion from the actual data copy to the snapshot, and the snapshot deleting processing described above can be managed as a consistency group. Here, different sections to the respective processings described above will be explained.

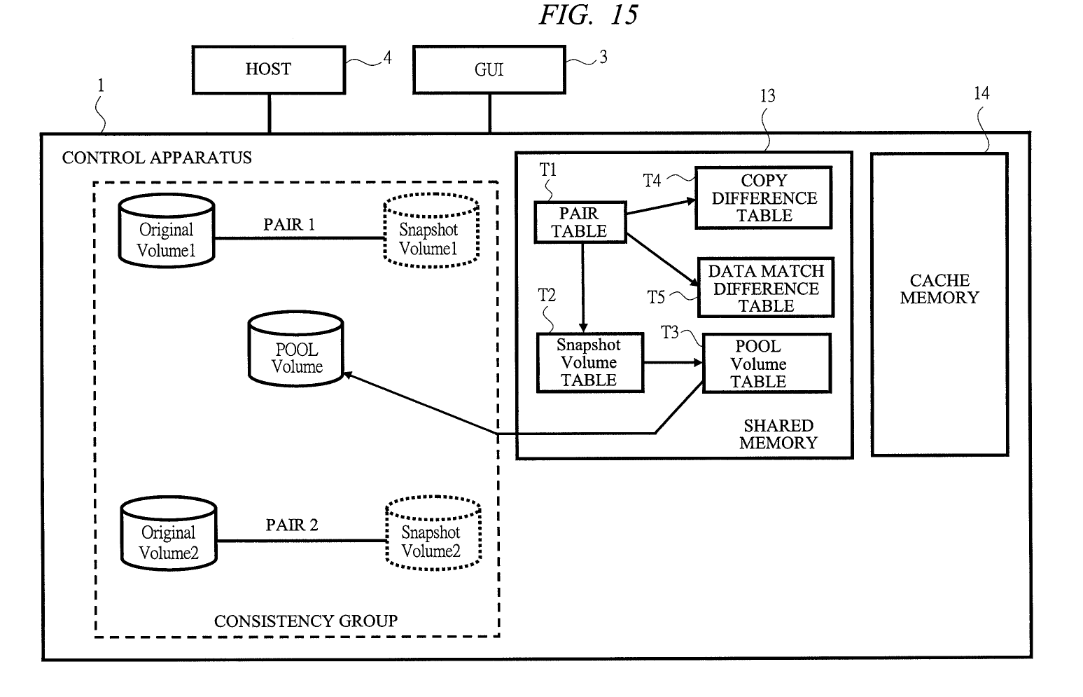

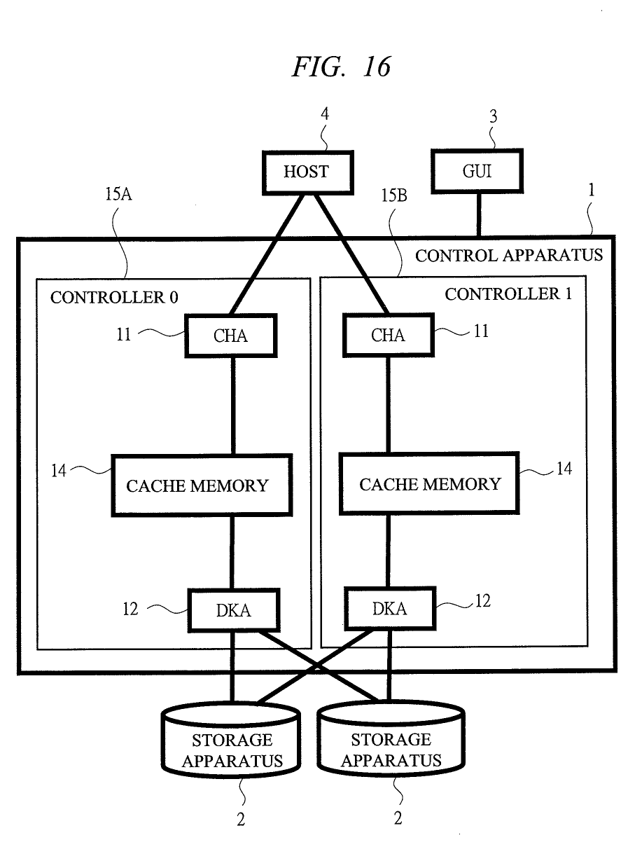

For example, in the conversion from the snapshot to the actual data copy, a plurality of pairs are managed as a consistency group. When a request for conversion from snapshot to actual data copy is received to the pairs in the consistency group, the above-mentioned conversion processing from snapshot to actual data copy regarding all pairs belonging to the consistency group is performed. A consistency group number is managed on the above-mentioned pair table T1 shown in FIG. 3. Ones having the same consistency group number belongs to the same consistency group. Referring to FIG. 15, one example of the consistency group will be explained. FIG. 15 is a diagram for explaining the consistency group.

In FIG. 15, two pairs of a pair 1 of Original Volume 1 and Snapshot Volume 1 and a pair 2 of Original Volume 2 and Snapshot Volume 2 constitute a consistency group. Thereby, when a request for conversion from snapshot to actual data copy is received to the consistency group including the two pairs, a conversion processing from snapshot to actual data copy is performed regarding the pair 1 and the pair 2.

Thus, the present invention can also be applied to the case that a plurality of pairs is managed as a consistency group.

<Control Method of Midrange Controllers>

The present invention can be applied to not only the high end system configuration but also a midrange system configuration. Referring to FIG. 16, one example of a whole configuration of a storage system with the midrange system configuration will be explained. FIG. 16 is a diagram for explaining a storage system with a midrange system configuration. Here, different portions of the midrange system configuration from the above-mentioned high-end system configuration will be explained.

The storage system with the midrange system configuration has a plurality of (two in FIG. 16) controllers 15 (a controller 0 (15A) and a controller 1 (15B)) within the control apparatus 1, where the respective controllers 15 can operate independently. Each of the controllers 15 includes a CHA 11, a DKA 12, and a cache memory 14 having functions similar to those of the high-end system configuration.

In the midrange system configuration, there are the following pattern 1, pattern 2, and pattern 3 according to kinds of volumes to be controlled by the controllers 15 (Original Volume, Snapshot Volume, and POOL Volume).

In the pattern 1, all of Original Volume, Snapshot Volume, and POOL Volume are controlled by the controller 0 (15A).

In the pattern 2, Original Volume is controlled by the controller 0 (15A), while Snapshot Volume and POOL Volume are controlled by the controller 1 (15B).

In the pattern 3, Original Volume and POOL Volume are controlled by the controller 0 (15A), while Snapshot Volume is controlled by the controller 1 (15B).

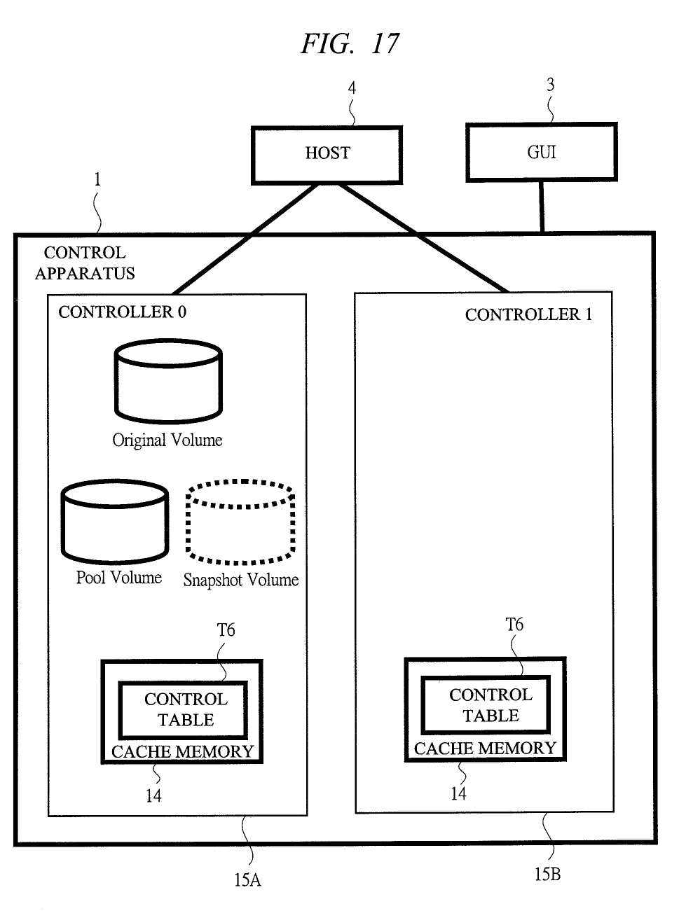

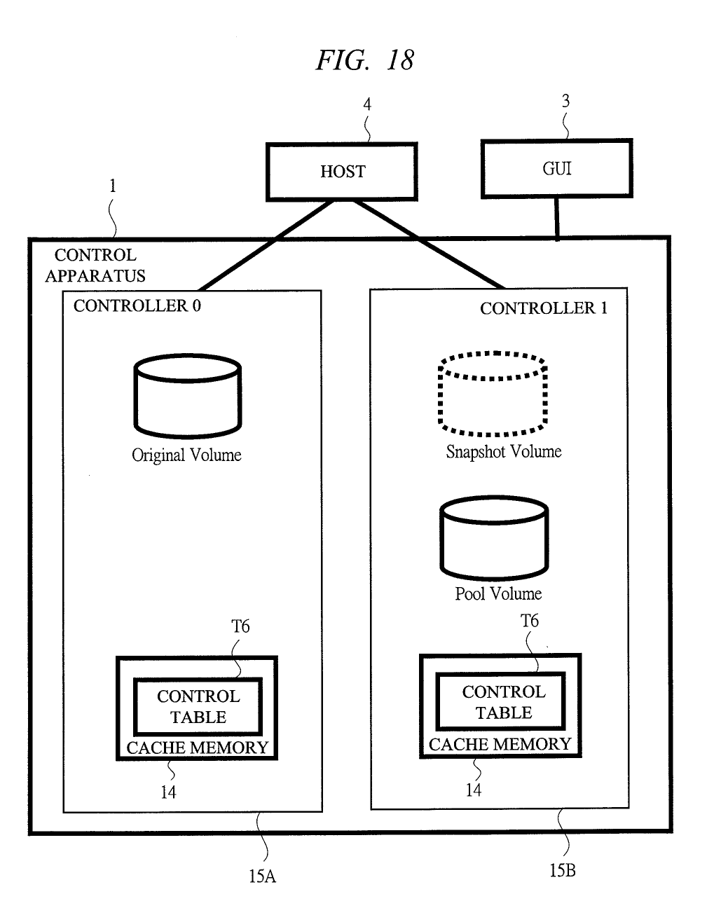

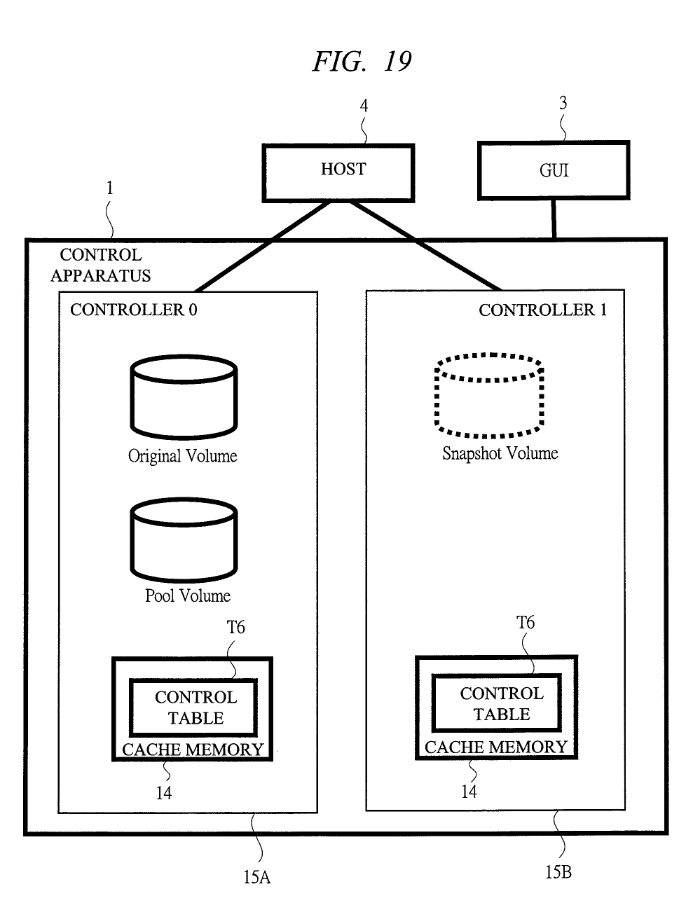

Processings to be newly conducted according to sharing of management for control of the pattern 1, the pattern 2, and the pattern 3 include the following (1) to (3). Referring to FIG. 17 to FIG. 19, one example of the processings to be newly performed will be explained. FIG. 17 is a diagram for explaining the pattern 1, FIG. 18 is a diagram for explaining the pattern 2, and FIG. 19 is a diagram for explaining the pattern 3.

(1) As shown in FIG. 17, cache memories 14 in the controller 0 (15A) and the controller 1 (15B) have equal control tables T6 (a pair table, a Snapshot Volume table, a POOL Volume table, a copy difference table, and a data match difference table). It is assumed that the contents of the control tables T6 always match with each other. When the control table T6 of one controller 15A (15B) is updated, update to the control table T6 of the other controller 15B (15A) is conducted via the host 4.

(2) As shown in FIG. 18, when Original Volume and Snapshot Volume are put under controls of different controllers (the pattern 2) like a case that Original Volume is put under control of the controller 0 (15A) while Snapshot Volume is put under control of the controller 1 (15B), data copy between both the Volumes is performed via the host 4.

(3) As shown in FIG. 19, when actual data of Volume received through host access is put under control of the other controller like a case that Original Volume and POOL Volume are put under control of the controller 0 (15A) while Snapshot Volume is put under control of the controller 1 (15B), data access is performed via the host 4.

Thus, the present invention can be applied to the storage system with the midrange system configuration.

<External Connection>

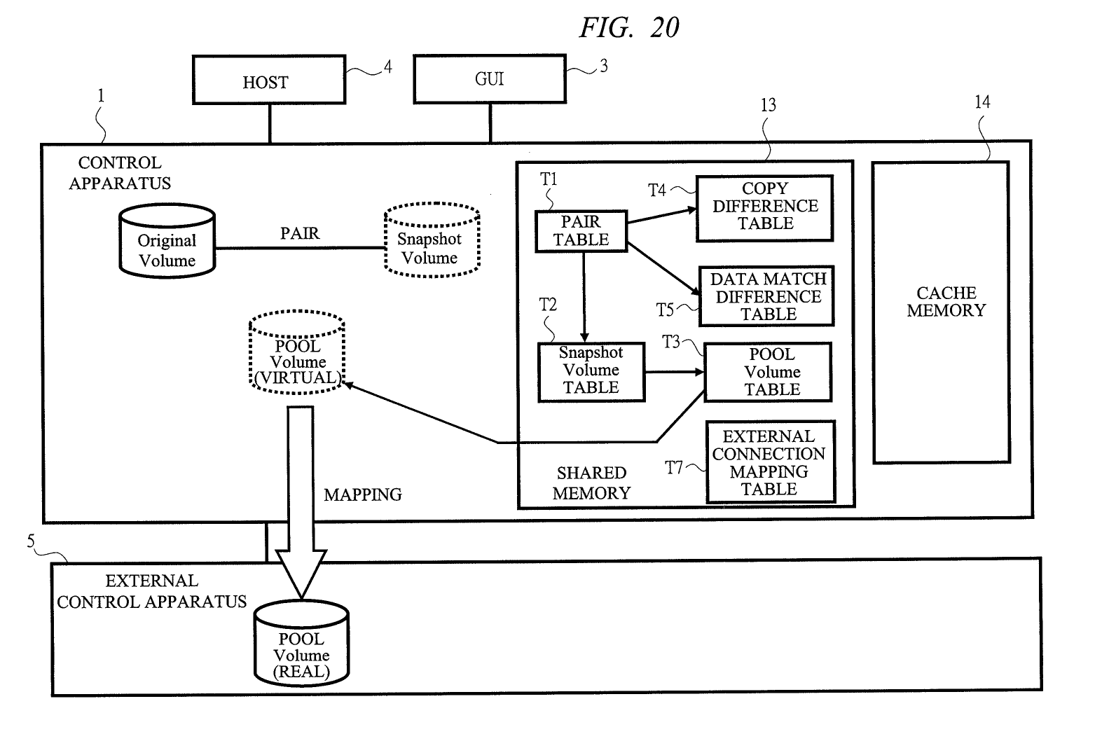

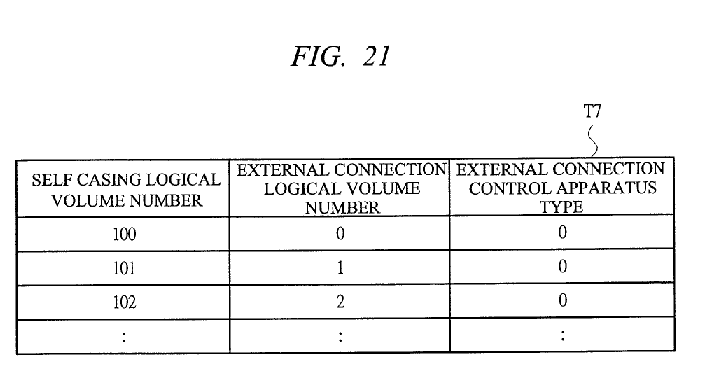

In the present invention, it is possible to set the above-mentioned POOL Volume as a logical volume in an externally connected storage. Referring to FIG. 20 and FIG. 21, one example of the external connection will be explained. FIG. 20 is a diagram for explaining external connection and FIG. 21 is a diagram showing a configuration of an external connection mapping table.

As shown in FIG. 20, in a configuration where Original Volume, Snapshot Volume, and POOL Volume (virtual) are present in the control apparatus 1 and POOL Volume (real) is present in an external control apparatus 5 positioned outside of the control apparatus 1, when POOL Volume is accessed, the external connection mapping table T7 provided in the shared memory 13 is looked up and an external connection logical volume number of an external connection control apparatus type is accessed. Thereby, POOL Volume in the external control apparatus 5 can be utilized.

As shown in FIG. 21, the external connection mapping table T7 includes respective areas for storing a self casing logical volume number, for storing an external connection logical volume number, and for storing an external connection control apparatus type. Mapping between a logical volume of the self-casing and a logical volume of the external connection can be conducted according to the external connection mapping table T7.

Thus, the present invention can also be applied to the case that POOL Volume is set as a volume in the external connection storage.

### Effect of Embodiment

According to the embodiment, when a request for conversion from snapshot to actual data copy is received, conversion from the snapshot to the actual data copy is made possible by copying data in Original Volume to POOL Volume, so that either of the backup aspects can be selectively used arbitrarily according to priority of a volume capacity, a write command overhead, and a system performance.

As a result, since copy-on-write operation to Original Volume does not occur, performance degradation of a write command from the host can be avoided.

In addition, when a request for conversion from actual data copy to snapshot is received, a conversion processing from the actual data copy to the snapshot can be performed.

Furthermore, transition among the respective states of the state having no pair, the state where copying has not been from Original Volume to Snapshot Volume (Original Volume≠POOL Volume), the state where copying has been performed from Original Volume to Snapshot Volume (Original Volume≠POOL Volume), and the state where copying has been performed from Original Volume to Snapshot Volume (Original Volume=POOL Volume) can be caused.

Management of Original Volume and Snapshot Volume can be applied to not only the case of one pair but also a configuration that a plurality of pairs are managed as a consistency group.

The configuration of the storage system can be applied to not only the high-end system configuration but also the midrange system configuration.

POOL Volume can be applied to not only the logical volume of the self-casing but also the logical volume in the external connection storage.

In the foregoing, the invention made by the inventor of the present invention has been concretely described based on the embodiments. However, it is needless to say that the present invention is not limited to the foregoing embodiments and various modifications and alterations can be made within the scope of the present invention.

What is claimed is:

1. A storage system comprising a channel control unit that receives a request for a read operation or a write operation from a host to control the read operation or the write operation, a storage device that stores data obtained according to the read operation or the write operation, a storage device control unit that controls a read operation or a write operation of data to the storage device, a shared memory in which control information fed by the channel control unit and the storage device control unit is stored, and a cache memory in which data fed between the channel control unit and the storage device control unit is temporally stored,
wherein an original volume that is a logical volume where original data is stored at a snapshot creating time, a snapshot volume that is a virtual logical volume constituting a snapshot volume at the snapshot creating time, and a pool volume that is a logical volume that stores actual data of the snapshot volume therein after creation of the snapshot volume are set in the storage device,
the shared memory includes a pair table that manages pair correspondence between the original volume and the snapshot volume, a copy difference table that indicates whether data has been copied from the original volume to the pool volume, and a data match difference table that indicates whether data in the original volume and data in the pool volume match with each other,
when a request for conversion from snapshot to actual data copy is received externally,
the channel control unit,
without deleting a pair of the original volume and the snapshot volume in the pair table,
scans the copy difference table from a leading bit thereof, copies non-copied data from the original volume to the pool volume, changes a corresponding bit in the copy difference table to a copied bit after the copying is completed, and changes a corresponding bit in the data match difference table to match,
regarding all bits in the copy difference table, changes a corresponding bit in the copy difference table to a copied bit and changes a backup type of the pair table to actual data copy after a processing for changing the corresponding bit in the data match difference table to match is completed.

2. The storage system according to claim 1,
wherein the shared memory further comprises a pool volume table in which an entry number in pool and an address of actual data corresponding to the entry are stored,
when a request for conversion from the actual data copy to the snapshot is received externally,
the channel control unit,
without deleting a pair of the original volume and the snapshot volume in the pair table,
changes a backup type of the pair table to snapshot,
scans the data match difference table from a leading bit thereof to changes an entry number in pool at a location with data match to an invalid value,
changes a data address of the entry number in pool corresponding to the location with data match in the pool volume table to an invalid value, and
changes a bit corresponding to the location with data match in the copy difference table to non-copy.

3. The storage system according to claim 2,
wherein the shared memory further comprises a snapshot volume table including a data section that manages actual data positions in the snapshot volume for each location, where an entry number in pool is stored when actual data in the snapshot volume is present in the pool volume and an invalid value is stored when actual data is absent in the pool volume, and a header section that manages use/non-use of the data section in a bitmap manner, and
when a deleting processing of the snapshot is performed,
the channel control unit
changes a data address of the pool volume table corresponding to an entry number in pool that is not an invalid value in the snapshot volume table to an invalid value,
changes a corresponding use bit of the header section in the snapshot volume table to non-use and changes all entry numbers in pool to invalid values, and
clears an original volume number and a snapshot volume number in the pair table to zero to change a snapshot volume table address and a backup type to invalid values.

4. The storage system according to claim 1,
wherein the shared memory further comprises a pool volume table in which an entry number in pool and an address of actual data corresponding to the entry are stored, a data section that manages actual data positions in the snapshot volume for each location, where an entry number in pool is stored when actual data in the snapshot volume is present in the pool volume and an invalid value is stored when actual data is absent in the pool volume, and a header section that manages use/non-use of the data section in a bitmap manner,
when a request for creating the snapshot is received externally,
the channel control unit
retrieves an entry whose backup type is invalid in the pair table to register an original volume number and a snapshot volume number,
retrieves the header section of the snapshot volume table to set an address in an unused data section to a snapshot volume table address,
changes the backup type of the pair table to snapshot,
changes an entry number in pool in the snapshot volume table to an invalid value,
changes all bits in the copy difference table to non-copied bits, and
changes all bits in the data match difference table to mismatch.

5. The storage system according to claim 4,
wherein, when a read operation from the upper apparatus to the original volume is performed after creation of the snapshot,
the channel control unit
reads data in the original volume without updating the copy difference table and the data match difference table, and
when a write operation from the upper apparatus to the original volume is performed after creation of the snapshot,
the channel control unit
looks up the copy difference table and, when data has not been copied from the original volume to the pool volume, writes write data in the original volume after the copying is performed, updates the copy difference table from a non-copied one to a copied one, and keeps the data match difference table in mismatch, while, when the copied has been completed, writing the write data in the original volume, keeping the copy difference table as the copied one, and updating the data match difference table from match to mismatch.

6. The storage system according to claim 5,
wherein, when a data copying processing from the original volume to the pool volume generated according to a read access or a write access from the upper apparatus is performed,
the channel control unit
retrieves an entry number in pool whose data address is an invalid value in entries of the pool volume table,
updates a data address corresponding to the entry number in pool whose data address is an invalid value to a data address for actually performing copying,
updates an entry number in pool in the snapshot volume table to the entry number in pool whose data address is an invalid value, and
copies the data from the original volume to the pool volume.

7. The storage system according to claim 4,
wherein, when a read operation from the upper apparatus to the snapshot volume is performed after creation of the snapshot,
the channel control unit
looks up the copy difference table and, when data has not been copied from the original volume to the pool volume, reads data in the pool volume after the copying is performed, updates the copy difference table to a non-copied one to a copied one, and updates the data match difference table from inconsistency to consistency, while, when the copied has been completed, reading data in the pool volume, and keeping the copy difference table as the copied one without updating the data match difference table, and
when a write operation from the upper apparatus to the snapshot volume is performed after creation of the snapshot,
the channel control unit
looks up the copy difference table and, when data has not been copied from the original volume to the pool volume, writes write data in the pool volume after the copying is performed, updates the copy difference table from a non-copied one to a copied one, and keeps the data match difference table in mismatch, while, when the copied has been completed, writing the write data in the pool volume, keeping the copy difference table as the copied one, and updating the data match difference table from match to mismatch.

8. The storage system according to claim 7,
wherein, when a data copying processing from original volume to pool volume generated by a read access or a write access from the upper apparatus,
the channel control unit
retrieves an entry number in pool whose data address is an invalid value in entries of the pool volume table,
updates a data address corresponding to the entry number in pool whose data address is an invalid value to a data address for actually performing data copying,
updates an entry number in pool in the snapshot volume table to the entry number in pool whose data address is an invalid value, and
copies the data from the original volume to the pool volume.

9. The storage system according to claim 1,
wherein the pair table is for managing a plurality of pairs as a consistency group, and
when a request for conversion from the snapshot to the actual data copy to a pair in the consistency group is received externally,
the channel control unit
performs a conversion processing from the snapshot to the actual data copy regarding all pairs belonging to the consistency group.

10. The storage system according to claim 9,
wherein, when a request for conversion from the actual data copy to snapshot to a pair in the consistency group is received externally,
the channel control unit
performs a conversion processing from the actual data copy to the snapshot regarding all pairs belonging to the consistency group.

11. A control method of a storage system comprising a channel control unit that receives a request for a read operation or a write operation from a host to control the read operation or the write operation, a storage device that stores data obtained according to the read operation or the write operation, a storage device control unit that controls a read operation or a write operation of data to the storage device, a shared memory in which control information fed by the channel control unit and the storage device control unit is stored, and a cache memory in which data fed between the channel control unit and the storage device control unit is temporally stored,
wherein an original volume that is a logical volume where original data is stored at a snapshot creating time, a snapshot volume that is a virtual logical volume constituting a snapshot volume at the snapshot creating time, and a pool volume that is a logical volume that stores actual data of the snapshot volume therein after creation of the snapshot volume are set in the storage device,
the shared memory includes a pair table that manages pair correspondence between the original volume and the snapshot volume, a copy difference table that indicates whether data has been copied from the original volume to the pool volume, and a data match difference table that indicates whether data in the original volume and data in the pool volume match with each other,
when a request for conversion from snapshot to actual data copy is received externally,
the channel control unit,
without deleting a pair of the original volume and the snapshot volume in the pair table,
scans the copy difference table from a leading bit thereof, copies non-copied data from the original volume to the pool volume, changes a corresponding bit in the copy difference table to a copied bit after the copying is completed, and changes a corresponding bit in the data match difference table to match,
regarding all bits in the copy difference table, changes a corresponding bit in the copy difference table to a copied bit and changes a backup type of the pair table to actual data copy after a processing for changing the corresponding bit in the data match difference table to match is completed.

12. The control method of a storage system according to claim 11,
wherein the shared memory further comprises a pool volume table in which an entry number in pool and an address of actual data corresponding to the entry are stored,
when a request for conversion from the actual data copy to the snapshot is received externally,
the channel control unit,
without deleting a pair of the original volume and the snapshot volume in the pair table,
changes a backup type of the pair table to snapshot,
scans the data match difference table from a leading bit thereof to changes an entry number in pool at a location with data match to an invalid value,
changes a data address of the entry number in pool corresponding to the location with data match in the pool volume table to an invalid value, and
changes a bit corresponding to the location with data match in the copy difference table to non-copy.

13. The control method of a storage system according to claim 12,
wherein the shared memory further comprises a snapshot volume table including a data section that manages actual data positions in the snapshot volume for each location, where an entry number in pool is stored when actual data in the snapshot volume is present in the pool volume and an invalid value is stored when actual data is absent in the pool volume, and a header section that manages use/non-use of the data section in a bitmap manner, and
when a deleting processing of the snapshot is performed,
the channel control unit
changes a data address of the pool volume table corresponding to an entry number in pool that is not an invalid value in the snapshot volume table to an invalid value,
changes a corresponding use bit of the header section in the snapshot volume table to non-use and changes all entry numbers in pool to invalid values, and
clears an original volume number and a snapshot volume number in the pair table to zero to change a snapshot volume table address and a backup type to invalid values.

14. The control method of a storage system according to claim 11,
wherein the shared memory further comprises a pool volume table in which an entry number in pool and an address of actual data corresponding to the entry are stored, a data section that manages actual data positions in the snapshot volume for each location, where an entry number in pool is stored when actual data in the snapshot volume is present in the pool volume and an invalid value is stored when actual data is absent in the pool volume, and a header section that manages use/non-use of the data section in a bitmap manner,
when a request for creating the snapshot is received externally,
the channel control unit
retrieves an entry whose backup type is invalid in the pair table to register an original volume number and a snapshot volume number,
retrieves the header section of the snapshot volume table to set an address in an unused data section to a snapshot volume table address,
changes the backup type of the pair table to snapshot,
changes an entry number in pool in the snapshot volume table to an invalid value,
changes all bits in the copy difference table to non-copied bits, and
changes all bits in the data match difference table to mismatch.

15. The control method of a storage system according to claim 14,
wherein, when a read operation from the upper apparatus to the original volume is performed after creation of the snapshot,
the channel control unit
reads data in the original volume without updating the copy difference table and the data match difference table, and
when a write operation from the upper apparatus to the original volume is performed after creation of the snapshot,
the channel control unit
looks up the copy difference table and, when data has not been copied from the original volume to the pool volume, writes write data in the original volume after the copying is performed, updates the copy difference table from a non-copied one to a copied one, and keeps the data match difference table in mismatch, while, when the copied has been completed, writing the write data in the original volume, keeping the copy difference table as the copied one, and updating the data match difference table from match to mismatch.

16. The control method of a storage system according to claim 15,
wherein, when a data copying processing from the original volume to the pool volume generated according to a read access or a write access from the upper apparatus is performed,
the channel control unit
retrieves an entry number in pool whose data address is an invalid value in entries of the pool volume table,
updates a data address corresponding to the entry number in pool whose data address is an invalid value to a data address for actually performing copying,
updates an entry number in pool in the snapshot volume table to the entry number in pool whose data address is an invalid value, and
copies the data from the original volume to the pool volume.

17. The control method of a storage system according to claim 14,
wherein, when a read operation from the upper apparatus to the snapshot volume is performed after creation of the snapshot,
the channel control unit
looks up the copy difference table and, when data has not been copied from the original volume to the pool volume, reads data in the pool volume after the copying is performed, updates the copy difference table to a non-copied one to a copied one, and updates the data match difference table from inconsistency to consistency, while, when the copied has been completed, reading data in the pool volume, and keeping the copy difference table as the copied one without updating the data match difference table, and
when a write operation from the upper apparatus to the snapshot volume is performed after creation of the snapshot,
the channel control unit
looks up the copy difference table and, when data has not been copied from the original volume to the pool volume, writes write data in the pool volume after the copying is performed, updates the copy difference table from a non-copied one to a copied one, and keeps the data match difference table in mismatch, while, when the copied has been completed, writing the write data in the pool volume, keeping the copy difference table as the copied one, and updating the data match difference table from match to mismatch.

18. The control method of a storage system according to claim 17,
wherein, when a data copying processing from original volume to pool volume generated by a read access or a write access from the upper apparatus,
the channel control unit
retrieves an entry number in pool whose data address is an invalid value in entries of the pool volume table,
updates a data address corresponding to the entry number in pool whose data address is an invalid value to a data address for actually performing data copying,
updates an entry number in pool in the snapshot volume table to the entry number in pool whose data address is an invalid value, and
copies the data from the original volume to the pool volume.

19. The control method of a storage system according to claim 11,
wherein the pair table is for managing a plurality of pairs as a consistency group, and
when a request for conversion from the snapshot to the actual data copy to a pair in the consistency group is received externally,
the channel control unit
performs a conversion processing from the snapshot to the actual data copy regarding all pairs belonging to the consistency group.

20. The control method of a storage system according to claim 19, wherein,
when a request for conversion from the actual data copy to snapshot to a pair in the consistency group is received externally,
the channel control unit
performs a conversion processing from the actual data copy to the snapshot regarding all pairs belonging to the consistency group.
